(19) United States
(12) Patent Application Publication
(10) Pub. No.: US 2019/0173747 A1
(43) Pub. Date: Jun. 6, 2019

(54) System for Creating a Personal Communications Network

(71) Applicants: Jacob Jara, Olivehurst, CA (US); Vishnu Sivadas, Folsom, CA (US)

(72) Inventors: Jacob Jara, Olivehurst, CA (US); Vishnu Sivadas, Folsom, CA (US)

(21) Appl. No.: 16/211,213

(22) Filed: Dec. 5, 2018

Related U.S. Application Data
(60) Provisional application No. 62/594,652, filed on Dec. 5, 2017.

(51) Int. Cl. H04L 12/24; H04W 76/15

(52) U.S. Cl. CPC H04L 41/0806; H04W 84/18; H04W 76/15

(57) ABSTRACT

A system for creating a personal communications network is used to transfer audio and video data between users without the need for a third-party network hosting framework. The system makes use of communications hubs to act as distributed processing nodes that receive user input and enable communication between groups of local network devices. The communications hub is a computing device that is capable of coordinating the communication operations of the network devices. To that end, the communications hub has a housing, a control system, and a wireless communications system. The control system and the wireless communications system work in concert to enable the communications hub to act as an off-site data-processing unit for the network devices. The communications hub enables multiple users to wirelessly send and receive data through the connected network devices. Thereby, creating an ad-hoc communications network and removing the need for dedicated network infrastructure.

The current application claims a priority to the U.S. Provisional Patent application Ser. No. 62/594,652 filed on Dec. 5, 2018.

### FIELD OF THE INVENTION

The present invention relates generally to a two-way communications system. More specifically, the present invention relates to a system for generating an ad-hoc network of devices that is capable of sharing audio and video information.

### BACKGROUND OF THE INVENTION

Over the last decade, smart hubs have risen in popularity. A smart hub is a computing device that can connect to, and coordinate the operations of, multiple network devices. A display or user interface can be integrated into the smart hub to enable the user to issue commands and interact with system information. Smart hubs have been improved in both functionality and practicality over the years. Current smart hubs provide greater functionality and capabilities, such as allowing users to make calls and/or have videocalls through the smart hub. While the newer functionality and capabilities make the smart hubs more useful, currently available smart hubs are not stand-alone or portable devices. This limitation requires traditional smart hubs to be connected to an external system for data processing and information gathering. Even though newer smart hubs can have applications which can work without the paired external system, most functions such as calling, or video calling, require pairing to the external system. The limitations include the inability to send and receive data over long distances. Of course, most currently available smart hubs include some type of short distance communication technology, such as Bluetooth, to communicate with the paired electronic device. However, that technology does not allow users to call other users or send messages over long distances. Thus, a smart hub which does not require to be paired to the external system in order to perform communication tasks such as calling and/or video calling is beneficial and necessary.

An objective of the present invention, the system for creating a personal communications network, is to provide a self-contained smart hub which can work without the need of being paired to the external system. Another objective of the present invention is to provide a radio-controlled smart hub which can transmit and receive data utilizing radio frequencies. Another objective of the present invention is to provide a smart hub which can switch between radio frequencies and high-speed wireless communication technologies in order to maintain high performance. Another objective of the present invention is to provide a smart hub which allows group calls to be made between a plurality of users. To accomplish this, the present invention provides a smart hub system that can be wirelessly coupled to other smart hub systems. Thus, enabling two-way communication between users who are interacting with the smart hubs. Additionally, the smart hub provided by the present invention functions as a central communications node for communication between a plurality of network devices. The smart hub provided by the present invention then coordinates communications between the plurality of connected network devices. Thus, enabling multiple users to communicate among themselves with the smart hub provided by the present invention serving as the underlying communications infrastructure.

Another objective of the present invention is to provide a smart hub which protects information shared between users and maintain group calls and individual calls private. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a perspective view of the communications hub used in the present invention.

FIG. 2 is a front view of the communications hub used in the present invention.

FIG. 3 is a perspective view of the network device used in the present invention.

FIG. 4 is a block diagram illustrating connections between components of the present invention. In this figure, solid arrows indicate data flow and dashed arrows indicate electrical connections.

FIG. 5 is a block diagram illustrating connections between components of the communications hub used in the present invention.

FIG. 6 is a block diagram illustrating connections between components of the network device used in the present invention.

FIG. 7 is system overview showing data connections between multiple communications hubs and multiple network devices.

### DETAIL DESCRIPTIONS OF THE INVENTION

All illustrations of the drawings are for the purpose of describing selected versions of the present invention and are not intended to limit the scope of the present invention.

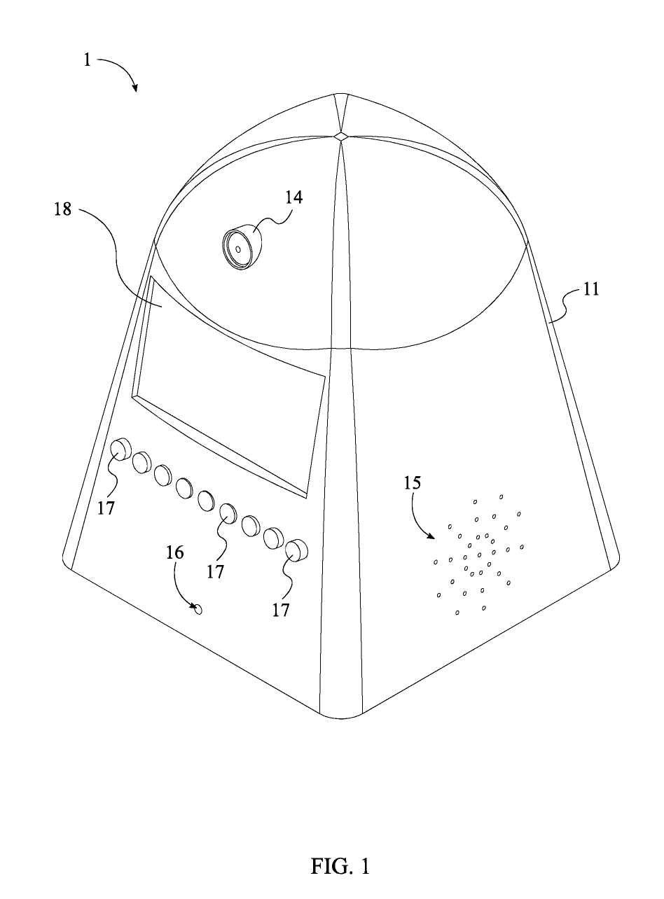

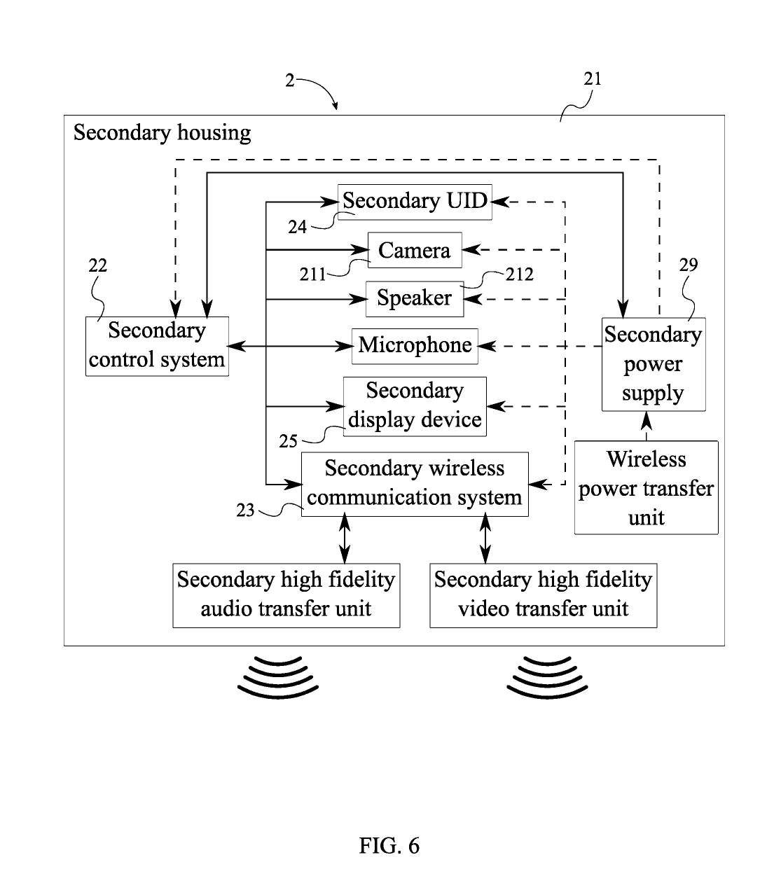

Referring to FIG. 1 through FIG. 7, the present invention, the system for creating a personal communications network, enables a user to generate an ad-hoc network of connected devices that is capable of transmitting high fidelity audio and video data. Additionally, the present invention is designed to enable the sharing of various other forms of digital content and user data. To achieve the above-described functionalities, the present invention comprises at least one communications hub 1. The communications hub 1 acts as a central processing node for the personal communications network. Specifically, the communications hub 1 is a self-contained computing device that can become wirelessly coupled to one or more external systems. Once coupled to the external systems the communications hub 1 enables a user to mediate the communication between one or more local devices. Additionally, a desired communications hub 1 can be coupled to at least one arbitrary communications hub 1. Thereby, enabling communication between a plurality of distinct groups of local devices. The communications hub 1 comprises a primary housing 11, a primary control system 12, and a primary wireless communication system 13. The primary housing 11 is an enclosure that is ergonomically designed to be functional while rested on a surface or held in a user's hand. The primary control system 12 is a processing unit that governs the operations of the communications hub 1. Additionally, the primary control system 12 is designed to perform the offloaded processing operations for the local devices. The primary wireless communication system 13 enables the communications hub 1 to be communicably coupled to the external systems. The primary control system 12 and the primary wireless communication system 13 are mounted within the primary housing 11. As a result, the primary housing 11 is able to protect the primary control system 12 and the primary wireless communication system 13 from water, dust, and other hazards in the external environment. The primary wireless communication system 13 is electronically connected to the primary control system 12. Accordingly, the primary control system 12 governs what data is sent and received by the primary wireless communications system 13.

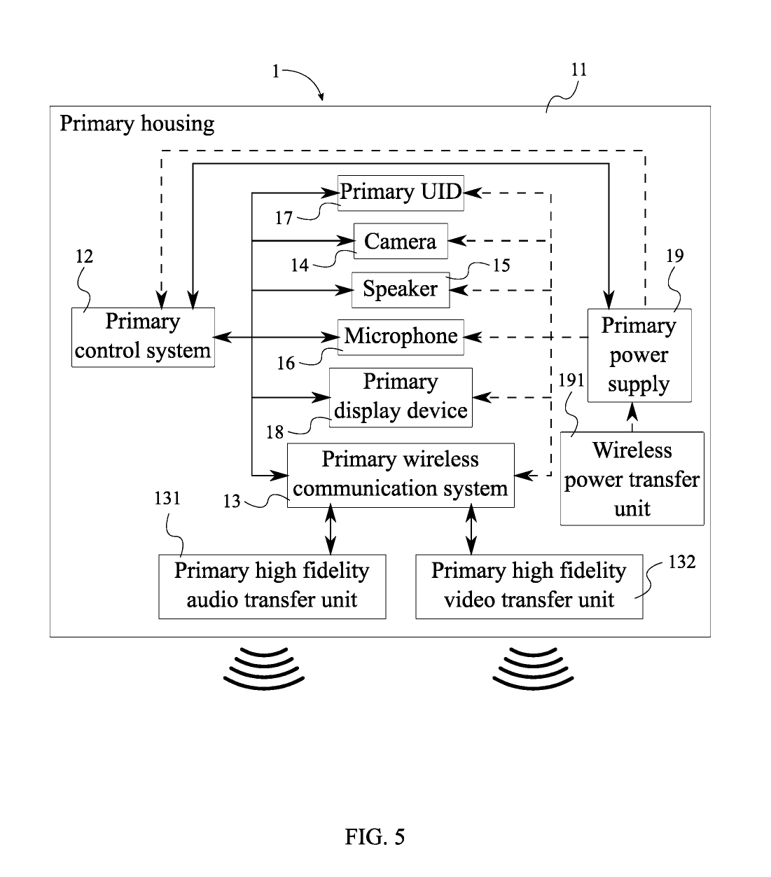

Referring to FIG. 1 and FIG. 5, the present invention is designed to create an independent communications network that enables multiple users to transmit and receive high fidelity audio and video data. To that end, the wireless communications system comprises a primary high-fidelity wireless audio transfer unit 131 and a primary high-fidelity wireless video transfer unit 132. The primary high-fidelity wireless audio transfer unit 131 and the primary high-fidelity wireless video transfer unit 132 are designed to use high throughput low latency transmission protocols to communicate audio and video data between the communications hub 1 and the external systems. This enables the desired communications hub 1 to act as a two-way communicator for audio and video calls. The primary wireless communication system 13 is designed to communicate over various wireless transmission protocols including, but not limited to, Wi-Fi, Bluetooth, NFC, radio transmission, and optical data transfer. Additionally, the primary wireless communication system 13 is designed to connect to and communicate with existing telecommunications infrastructure. To accomplish this, at least one digital to analog and at least one analog to digital converter are connected in between the primary wireless communication system 13 and the primary control system 12.

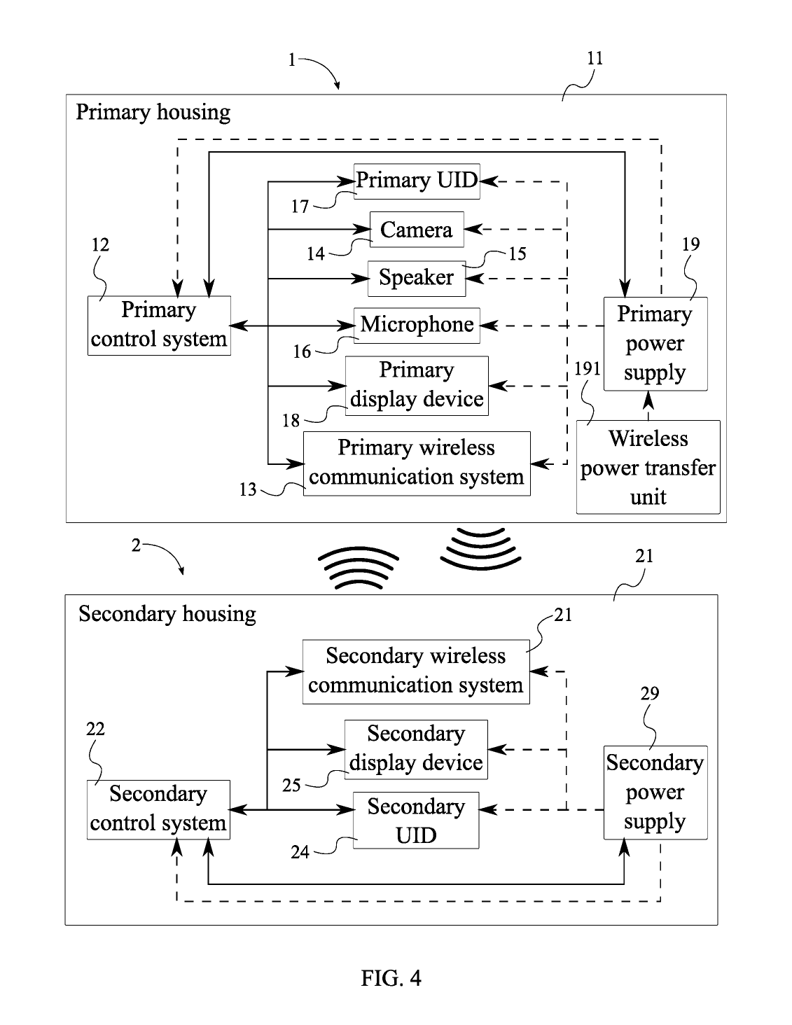

Referring to FIG. 4 and FIG. 5, preferably, the communications hub 1 is designed to be a stand-alone unit that is capable of functioning as a two-way communicator and data-processing unit. To achieve this functionality, the communications hub 1 further comprises a primary power supply 19 and a wireless power transfer unit 191. The primary power supply 19 and the wireless power transfer unit 191 are mounted within the primary housing 11. Accordingly, the housing protects the primary power supply 19 and the wireless power transfer unit 191 from water damage and other hazards in the external environment. The primary power supply 19 is electrically connected to the primary control system 12. As a result, the primary power supply 19 is able to satisfy the electrical requirements of operating the communications hub 1. The wireless power transfer unit 191 is electrically connected to the primary power supply 19 so that external systems are able to wirelessly transmit electrical power to the communications hub 1. Some embodiments of the communications hub 1 are equipped with a physical connections port. The physical connections port enables the external systems to be physically connected to the communications hub 1 for the purpose of transferring data and electrical power between the two devices. The communications hub 1 is designed to act as a battery pack that supplies electrical power to external systems.

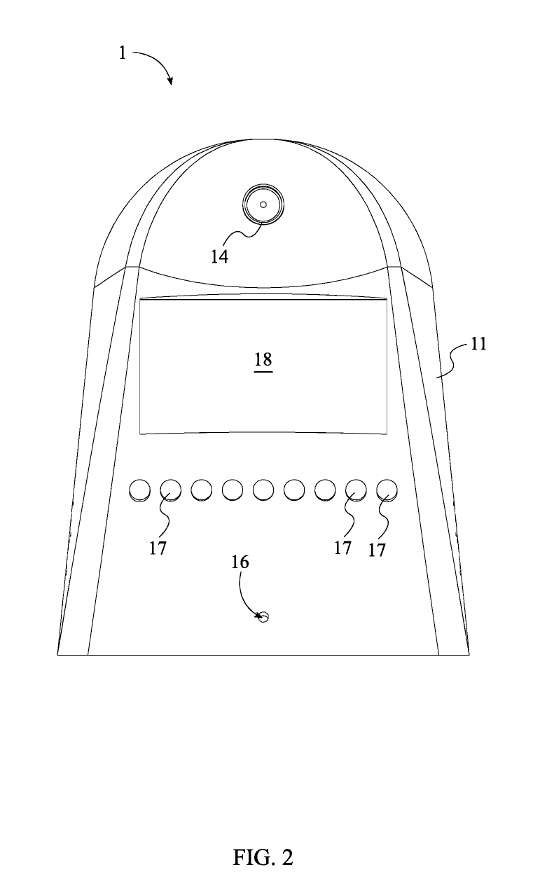

Referring to FIG. 1 and FIG. 2, as described above, the communications hub 1 is designed to function as a computing device with which the user directly interacts. To achieve this functionality, the communications hub 1 further comprises a primary user interface device (UID) 17, a primary display device 18, at least one primary camera 14, at least one primary speaker 15, at least one primary microphone 16. The primary UID 17, the primary display device 18, the primary camera 14, and the primary microphone 16 are externally mounted onto the primary housing 11 and advantageously positioned to facilitate receiving user input and relaying information to the user. The primary speaker 15 is integrated into the primary housing 11 so that the communications hub 1 can generate audible noises. The primary UID 17, the primary display device 18, the primary camera 14, the primary microphone 16, and the primary speaker 15 are electronically connected to the primary control system 12. Accordingly, the primary control system 12 is able to govern the operation of the primary UID 17, the primary display device 18, the primary camera 14, the primary microphone 16, and the primary speaker 15.

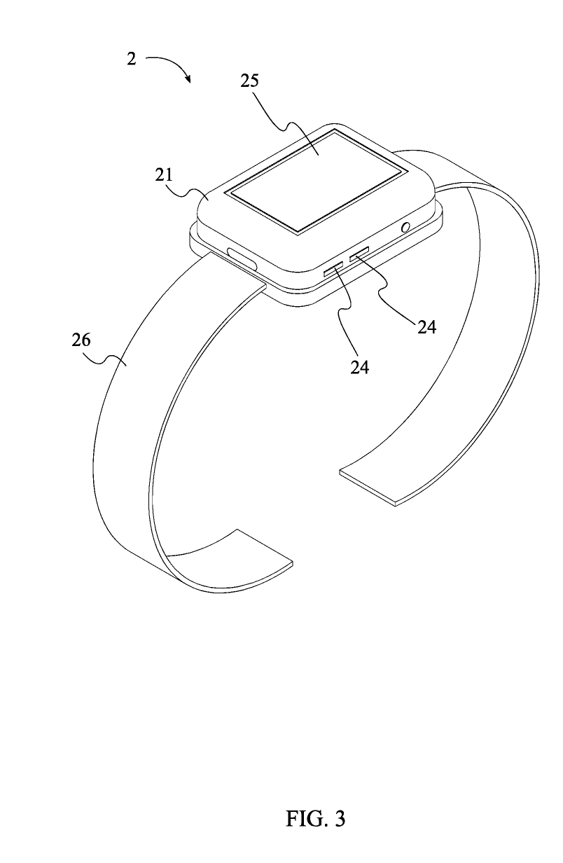

Referring to FIG. 3 and FIG. 4, the communications hub 1 is designed to act as a data-processing unit which coordinates the communication operations of one or more local devices. As such, the communication hub 1 enables the local devices to communicate among themselves. To that end, the present invention further comprises at least one network device 2. The network device 2 is an electronic system that is designed to gather data from the external environment and relay this data to the communications hub 1. Preferably, a plurality of network devices 2 is used to form an Internet of things network that uses the communications hub 1 to coordinate data flow. The network device 2 comprises a secondary housing 21, a secondary control system 22, and a secondary wireless communication system 23. The secondary housing 21 is an enclosure that is ergonomically designed to be functional while rested on a surface, held in the user's hand, or worn on the user's body. The secondary control system 22 is a processing unit that governs the operations of the network device 2. Additionally, the secondary control system 22 is designed to offload processing operations to the communications hub 1. The secondary wireless communication system 23 enables the network device 2 to be communicably coupled to the external systems. The secondary control system 22 and the secondary wireless communication system 23 are mounted within the secondary housing 21. As a result, the secondary housing 21 is able to protect the secondary control system 22 and the secondary wireless communication system 23 from water, dust, and other hazards in the external environment. The secondary wireless communication system 23 is electronically connected to the secondary control system 22. Accordingly, the secondary control system 22 governs what data is sent and received by the wireless communications system. The secondary wireless communication system 23 is communicably coupled to the primary wireless communication system 13 so that data can be passed between the two devices. Preferably, the network device 2 is a smartwatch that is coupled to the communications hub 1. This enables the smartwatch to receive updates and information from external sources. The network device 2 further comprises a fastening mechanism 26. The fastening mechanism 26 is externally mounted onto the secondary housing 21 so that the network device 2 can be attached to an external object. The fastening mechanism 26 is preferably a watchstrap which enables the network device 2 to be attached to the user's wrist.

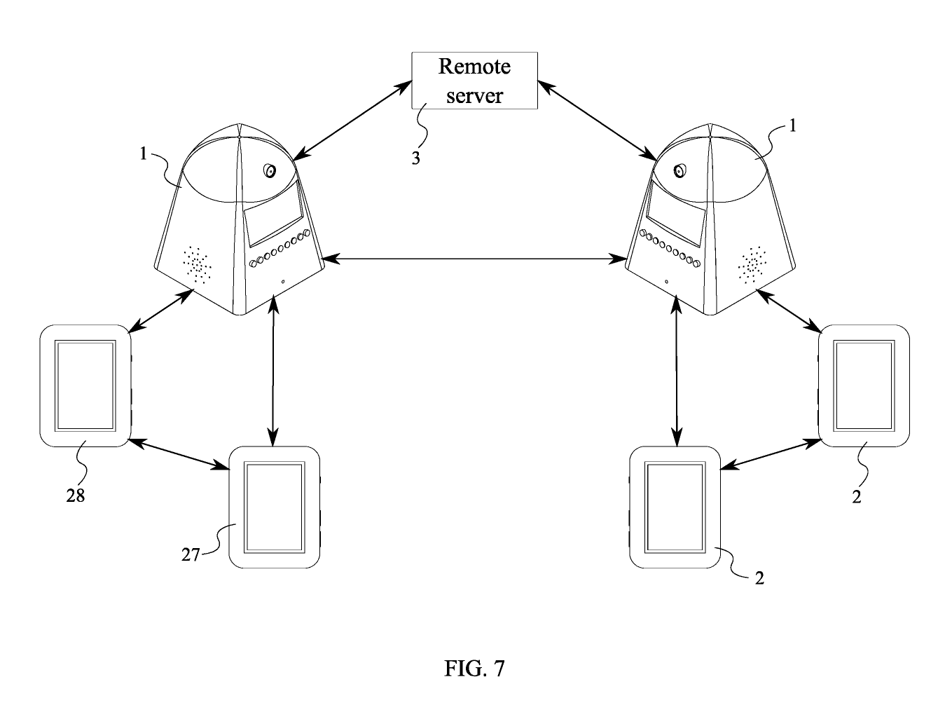

Referring to FIG. 1, FIG. 4, and FIG. 7, preferably, the network device 2 is designed to be a locally operated device that uses the communications hub 1 as a local datacenter. To achieve this functionality, the network device 2 further comprises a secondary UID 24, a secondary display device 25, at least one secondary camera 211, at least one secondary speaker 212, at least one secondary microphone. The secondary UID 24, the secondary display device 25, the secondary camera 211, and the secondary microphone are externally mounted onto the secondary housing 21 and advantageously positioned to facilitate receiving user input and relaying information to the user. The secondary speaker 212 is integrated into the secondary housing 21 so that the network device 2 can generate audible noises. The secondary UID 24, the secondary display device 25, the secondary camera 211, the secondary microphone, and the secondary speaker 212 are electronically connected to the secondary control system 22. Accordingly, the secondary control system 22 is able to govern the operation of the secondary UID 24, the secondary display device 25, the secondary camera 211, the secondary microphone, and the secondary speaker 212. Some embodiments of the network device 2 are equipped with a physical connections port. The physical connections port enables the external systems to be physically connected to the network device 2 for the purpose of transferring data and electrical power between the two devices.

Referring to FIG. 1 and FIG. 7, the present invention is designed to generate communications networks between a group of users. To facilitate this, the preset invention further comprises at least one remote server 3. Additionally, the at least one network device 2 can be a plurality of network devices 2 comprising a desired network device 27 and at least one arbitrary network device 28. In this scenario, the desired network device 27 is associated to a first user and the arbitrary network device 28 is associated to an arbitrary user. The desired network device 27 is communicably coupled to the arbitrary network device 28 so that the first user can communicate with the arbitrary user without being mediated by the communications hub 1. Additionally, the communications hub 1 is communicably coupled to the remote server 3. As a result, the communications hub 1 is able to send data to and receive data from external sources. The network device 2 is communicably coupled to the remote server 3 through the communications hub 1. Consequently, data from external sources is gathered and processed by the communications hub 1 prior to being transmitted to the network device 2. The communications hub 1 is designed to act as a central processor that coordinates the experience of multiple users who are interacting with the plurality of network devices 2. For example, the communications hub 1 can function as a game console that simultaneously relays real-time game information between the plurality of network devices 2.

Although the invention has been explained in relation to its preferred embodiment, it is to be understood that many other possible modifications and variations can be made without departing from the spirit and scope of the invention as hereinafter claimed.

What is claimed is:

1. A system for creating a personal communications network comprising:
at least one communications hub;
the communications hub comprising a primary housing, a primary control system, and a primary wireless communications system;
the primary control system being mounted within the primary housing;
the primary wireless communication system being mounted within the primary housing;
the primary wireless communication system being electronically connected to the primary control system;

2. The system for creating a personal communications network as claimed in claim 1 comprising:
the primary wireless communication system comprising a primary high-fidelity wireless audio transfer unit;
the primary high-fidelity wireless audio transfer unit being electronically connected to the primary control system;

3. The system for creating a personal communications network as claimed in claim 1 comprising:
the primary wireless communication system comprising a primary high-fidelity wireless video transfer unit;
the primary high-fidelity wireless video transfer unit being electronically connected to the primary control system;

4. The system for creating a personal communications network as claimed in claim 1 comprising:
the communications hub further comprising a primary power supply;
the primary power supply being mounted within the primary housing;
the primary power supply being electrically connected to the primary control system;

5. The system for creating a personal communications network as claimed in claim 4 comprising:
the communications hub further comprising a wireless power transfer unit;
the wireless power transfer unit being mounted within the primary housing;
the wireless power transfer unit being electrically connected to the primary power supply;

6. The system for creating a personal communications network as claimed in claim 1 comprising:
the communications hub further comprising a primary user interface device (UID);
the primary UID being externally mounted onto the housing;
the primary UID being electronically connected to the primary control system;

7. The system for creating a personal communications network as claimed in claim 1 comprising:
the communications hub further comprising a primary display device;
the primary display device being externally mounted onto the housing;
the primary display device being electronically connected to the primary control system;

8. The system for creating a personal communications network as claimed in claim 1 comprising:
the communications hub further comprising at least one primary camera;
the primary camera being externally mounted onto the housing;
the primary camera being electronically connected to the primary control system;

9. The system for creating a personal communications network as claimed in claim 1 comprising:
the communications hub further comprising at least one primary speaker;
the primary speaker being integrated into the housing;
the primary speaker being electronically connected to the primary control system;

10. The system for creating a personal communications network as claimed in claim 1 comprising:
the communications hub further comprising at least one primary microphone;
the primary microphone being externally mounted onto the housing;
the primary microphone being electronically connected to the primary control system;

11. The system for creating a personal communications network as claimed in claim 1 comprising:
at least one network device;
the network device comprising a secondary housing, a secondary control system, and a secondary wireless communication system;
the secondary control system being mounted within the secondary housing;
the secondary wireless communication system being mounted within the secondary housing;
the secondary wireless communication system being electronically connected to the secondary control system;
the secondary wireless communication system being communicably coupled to the primary wireless communication system;

12. The system for creating a personal communications network as claimed in claim 11 comprising:
at least one secondary camera;
the secondary camera being externally mounted onto the secondary housing;
the secondary camera being electronically connected to the secondary control system;

13. The system for creating a personal communications network as claimed in claim 11 comprising:
at least one secondary speaker;
the secondary speaker being externally mounted onto the secondary housing;
the secondary speaker being electronically connected to the secondary control system;

14. The system for creating a personal communications network as claimed in claim 11 comprising:
a secondary UID;
the secondary UID being externally mounted onto the secondary housing;
the secondary UID being electronically connected to the secondary control system;

15. The system for creating a personal communications network as claimed in claim 11 comprising:
a secondary display device;
the secondary display device being externally mounted onto the secondary housing;
the secondary display device being electronically connected to the secondary control system;

16. The system for creating a personal communications network as claimed in claim 11 comprising:
a fastening mechanism;
the fastening mechanism being externally mounted onto the secondary housing;

17. The system for creating a personal communications network as claimed in claim 11, wherein the fastening mechanism is a watch strap:

18. The system for creating a personal communications network as claimed in claim 11 comprising:
the at least one network device being a plurality of network devices;
the plurality of network devices comprising a desired network device and at least one arbitrary network device;
the desired network device being communicably coupled to the at least one arbitrary network device;

19. The system for creating a personal communications network as claimed in claim 11 comprising:
at least one remote server;
the network device being communicably coupled to the remote server through the communications hub;

20. The system for creating a personal communications network as claimed in claim 1 comprising:
at least one remote server;
the communications hub being communicably coupled to the remote server;
